(19) United States
(12) Patent Application Publication
(10) Pub. No.: US 2001/0040560 A1
(43) Pub. Date: Nov. 15, 2001

(54) VIDEO DISPLAY DOCUMENT

(76) Inventor: ALAN AMRON, SYOSSETT, NY (US)

Correspondence Address: Brian K. Dinicola Esq, 6 MICHAEL LANE, SPOTSWOOD, NJ, 08884, US

(21) Appl. No.: 09/137,380

(22) Filed: Aug. 20, 1998

(51) Int. Cl. G09G 5/00

(52) U.S. Cl. 345/169

(57) ABSTRACT

A video display system comprising a housing, a flat panel display, a memory storage module for storing data representative of an audio/video sequence, and a user input interface operable to cause the audio/video sequence to be visually displayed and audibly reproduced. In an illustrative embodiment of the present invention, the video display system is employed in a bound hybrid document such that the stored video sequence forms a part of the hybrid document. A plurality of aligned apertures are defined in the housing to accommodate the integration of the video display system within the bound hybrid document.

### BACKGROUND

1. Field of the Invention

This invention relates to a combination of the field of document presentation with the field of video storage and display systems and, more particularly, to a system and method of presenting a video sequence either as a discrete, individual document, or as an adjunct to printed materials within an integrated, hybrid master document.

2. Discussion of the Prior Art

Because the invention involves a combination relating to two very different fields, a brief description of the nature of the invention would help to give a framework in which to examine the prior art.

At different stages of the highly stylized field of trial advocacy, parties are required to prepare and submit documents in accordance with a rigid and comprehensive set of rules. These rules are typically concerned with such aspects as paper size, margins, line spacing, letter size and font, and even paper color. To the extent a party wishes, at a given stage of trial, to offer documentary exhibits in support of certain motions or pleadings for consideration by the judge, such exhibits must either comply with the applicable rules or defer action until that exhibit can be presented in a subsequent hearing. Disadvantageously, no satisfactory method has heretofore been available to the legal practitioner to facilitate the submission of audio/video evidence.

Stylized sets of document rules are not, of course, unique to the courts. Moreover, there are other situations in which it may be desirable to produce a hybrid document comprising both an audio/video component and a conventional component comprising printed sheets of paper, divider tabs, and the like. By way of illustrative example, hybrid documents of the aforementioned type might be employed in the preparation of promotional packages used in sales and marketing activities, comprehensive compilations of medical records, study aid materials, and many others.

It is further contemplated by the inventor herein that there are many other situations in which it would be beneficial to employ a “stand-alone” or self-contained video document capable of providing the user with a convenient, economically practical way to present a stored video sequence, slide show, sequence of graphs or charts, or some combination of these to an individual or group without the need for costly, non-specialized computer equipment.

The prior art which may be relevant to this invention is described hereinafter.

U.S. Pat. No. 4,159.417 to Rubincam discloses a portable, battery powered electronic viewer that reads and displays data stored in a holographic memory card. The memory can be page oriented so that each hologram represents a page in a book and the entire book can be stored on one card. An alternative embodiment provides a book-sized container hinged like a book so that 2 opposing displays can be read in a manner similar to the reading of a book. The device incorporates controls for controlling pagination, for adjusting the speed of leafing through the book and for displaying and entering page numbers. This disclosure describes facing displays mounted in a hinged book-sized device with plug-in memory card storage for a single book and functions that provide page control.

U.S. Pat. No. 4,545,023 to Mizzi discloses a handheld, battery-powered computer comprising various electronic cards and a flat touch screen. The touch screen eliminates the need for a keyboard or other input keypads. The screen can display alphanumeric characters and graphics. Any area touched on the screen is identified by its coordinates. The device can be connected to a remote host computer via an acoustic coupler and a telephone line. The device can be adapted for particular uses such as hand-writing recognition or TV or radio receiving by plugging in special purpose electronic cards. This disclosure describes a battery-powered, handheld computer that uses a large, flat touch screen display to replace a mechanical keyboard and that has the facilities to communicate with a remote host over telephone lines.

U.S. Pat. No. 4,649,499 to Sutton et al. discloses computer programs designed to emulate a three dimensional object such as a rotary card file or a hand calculator on a computer touch screen. Functions are performed by touching appropriate symbols on the touch screen, for example, a knob to rotate the cards, a tab label to select and view a card, plus softkeys to perform other functions on the cards. An emulation that puts up a functional calculator touch screen display is also disclosed. This disclosure describes the interaction between a touch screen and the operation of a computer and software to present a display of information with softkey areas that are used to provide user control of the associated information or function.

U.S. Pat. No. 4,855,725 to Fernandez discloses a simulated book that uses a battery-powered microprocessor with ROM for the program and RAM storage for data and a large LCD screen to display up to 2 pages of information transmitted from a CD-ROM equipped PC over an attached infrared transceiver to a transceiver incorporated into the simulated book. The book uses a touch screen to display the data and to control paging through the material. The device automatically requests additional pages of information to be transmitted from the PC for storage in the book. Data storage is maintained by a battery powered RAM. An alternative version disclosed includes a keypad and a tactile pad switch for inputting requests for a particular page or to page forward or backward. The book displays a single page at a time with the program automatically requesting pages of information to be transmitted from the PC to the book on the fly as the user reads or pages through the book.

U.S. Pat. No. 4,918,632 to York discloses a battery-powered, portable touch screen computer designed with a multitude of holes along one edge so that the computer can be disguised as a 3-ring binder notebook to avoid theft.

U.S. Pat. No. 5,031,119 to Dulaney et al. discloses a handheld, keyboardless computer with a split liquid crystal display (LCD) screen, the top half of the screen displays an application and the bottom half displays a keyboard. A glass overlay with an electrically-conductive coating interacts with an electrically conductive pen so that the user can input keystrokes on the bottom half of the screen or use the pen to perform mouse-like functions on the top half.

U.S. Pat. No. 5,109,354 to Yamashita et al.. discloses a portable pocketbook device comprising a touch screen or pressure sensitive LCD display, a cursor, function keys and an on/off switch that is activated when the pocketbook device is opened. A hinged binding contains a battery pack and rings to hold expansion cards. A back cover contains the electronics and a power source. Multiple methods of communicating between the expansion cards and the pocketbook include fiber optics, LED links and electromagnetic induction along the rings. The screen can be touch sensitive or the unit can be setup with a pressure sensitive screen for hand writing recognition. The expansion cards provide the capability of adding and removing a plurality of databases.

U.S. Pat. No. 5,339,091 to Yamazaki et al. discloses a portable electronic book comprised of a LCD display, keybutton inputs or other external input facilities, an on/off switch activated by opening the cover, a hinged cover, a solar cell in the cover to power the unit, a connector for an external power source and a disk drive to read information from optical or floppy disks. Other memory devices could include magnetic tape and EPROMS. The screen incorporates pressure or photo sensors so the user can select and emphasize portions of the text for later recall.

In view of the foregoing discussion, it will be readily appreciated by those skilled in the art that a need exists for a video display unit which, when combined with conventional written materials, can be used to create an integrated, hybrid document consisting of both the printed word and one or more demonstrative motion video sequences, animated scenes, a series of graphs and/or charts, and the like. Moreover, a need exists for a video display unit which can be used in a stand-alone or independent fashion to present such video sequences or “video documents” to another individual or group.

### SUMMARY OF THE INVENTION

The aforementioned needs are addressed, and an advance is made in the art, by a video display system comprising a housing, a flat panel display, a memory storage module for storing data representative of an audio/video sequence, and a user input interface operable to cause the video sequence to initiate playback on the flat panel display.

In accordance with an illustrative embodiment of the present invention, in which the video display system is to be employed in a bound hybrid document such that the stored video sequence forms a part of the hybrid document, a plurality of apertures are defined either in the housing itself or in a binding attachment which is securable by, for example, adhesive means, to accommodate the integration of the video display system within the bound hybrid document. It is contemplated by the inventor herein that a wide variety of binding situations may be encountered by the user of the video display system in accordance with this embodiment of the invention. For this reason, the housing may be configured as two detachable sections, a first section housing the flat panel display and video storage module, and a second section defining one or more aperture patterns corresponding to a respective number of specific binding techniques. One form of the second section may, for example, be configured with three holes along the vertical and/or horizontal direction to facilitate insertion into a three-ring binder. Another form of the second section may be configured with velo binding openings along the vertical and/or horizontal direction. Yet another form of the second section may be configured with openings to accommodate a spiral or coil binding system. It will thus be readily appreciated by those skilled in the art that a wide variety of binding situations may be addressed in a simple, cost effective manner.

### BRIEF DESCRIPTION OF THE DRAWINGS

The various features and advantages of the invention will become apparent from a consideration of the detailed description which follows taken in conjunction with the drawings, in which:

FIG. 1 is a perspective view depicting a touch-screen implementation of the present invention, constituting a video document portion of an integrated hybrid document within a conventional three-ring binder;

FIGS. 2A-2C depict various alternative, detachable housing section configurations that are designed to accommodate different binding techniques and systems;

FIG. 3 is a block diagram depicting the interactions of the various internal components disposed within the housing of the illustrative embodiment of FIG. 1;

FIG. 4 depicts an alternate embodiment of the present invention which utilizes discrete individual pushbutton operators to advance, rewind, and initiate playback of the stored video document;

FIG. 5 depicts a video display document constructed in accordance with the present invention and affixed to an illustrative binding attachment to provide both a suitable binding surface for mounting in a holder and to allow the device to be more easily be manipulated just like a sheet of printed material in such a holder;

FIGS. 6A-6C are various views depicting an alternate binding attachment which may be used as an alternative to the illustrative attachment depicted in FIG. 5 to provide a suitable binding surface for mounting in a holder while allowing the device to be manipulated just like a sheet of printed material in such a holder; and

FIGS. 7A-7C depict various techniques for transferring video sequence data into video display devices of the type employed by the present invention.

### DETAILED DESCRIPTION OF THE INVENTION

Initially, it should be emphasized and understood that the present invention is believed to have applicability as either a stand alone unit, by which video sequence documents or presentations may be made to one or more individuals, or in conjunction with printed materials as part of a bound, hybrid document. Accordingly, although in the discussion which follows, particular reference will be made to specific embodiments of the invention relating to the creation of hybrid documents, such reference is for illustrative purposes only and should not be deemed to limit the scope of the invention herein.

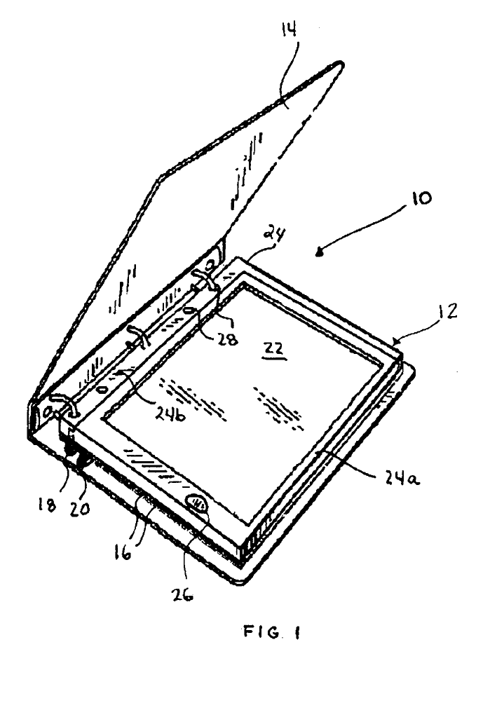

In any event, and with initial reference to FIG. 1, there is shown a hybrid integrated document 10 consisting of video display device 12, three-ring binder 14, and a plurality of individual sheets 16 of printed material, as for example, sheets of 8½″×11″ paper, separated by dividers 18 and 20. Video display device 12 includes a flat panel display 22 disposed within a housing 24. Housing 24 further includes a speaker 26 for audibly reproducing any sounds which may accompany the video sequence to be stored and played back using device 12.

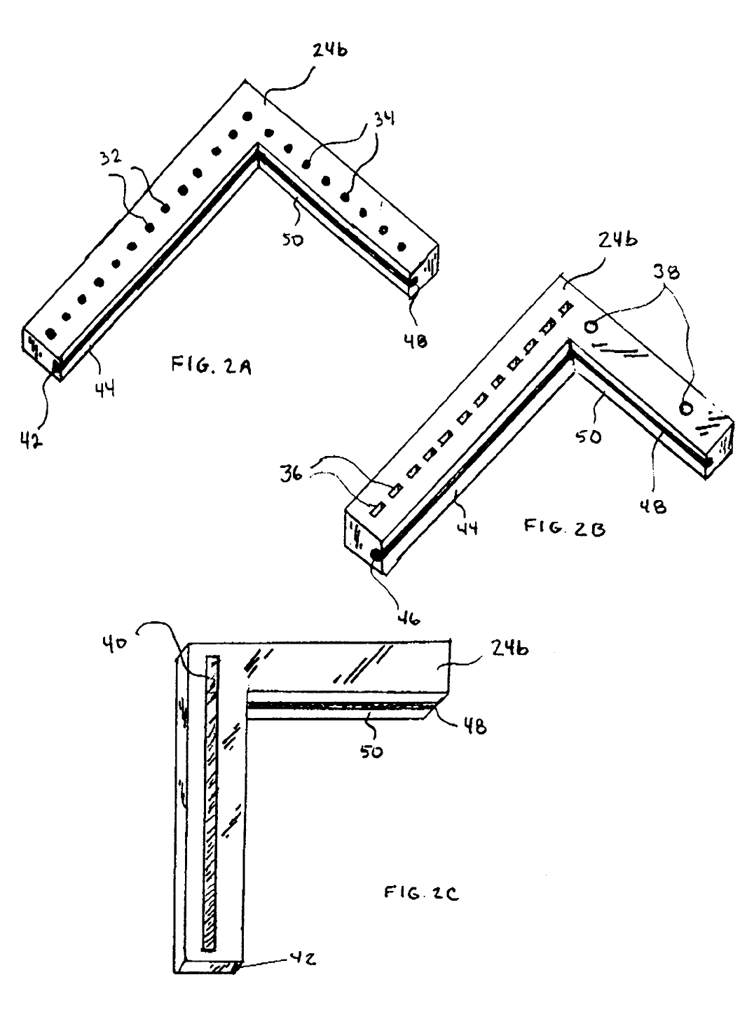

With continued reference to FIG. 1, it will be seen that housing 24 is actually configured as two, discrete, detachable sections, indicated generally at 24a and 24b. As will be described in greater detail shortly, section 24a houses the operative components of the display device 12 including, inter alia, flat panel display 22 and speaker 26, while section 24b defines a series of apertures intended to accommodate the integration of video display device 12 within a bound hybrid document such as hybrid document 10. It is contemplated by the inventor herein that a wide variety of binding situations may be encountered by the user of the video display system in accordance with this embodiment of the invention. As such section 24b may define one or more aperture patterns corresponding to any number of specific binding techniques. In addition to the embodiment of FIG. 1, in which two- and three-hole punch accommodations are provided by apertures 28 along the major axis of video display device 12, many other configurations are possible. A few non-limiting examples of these are shown in FIGS. 2A-2C, in which like numerals refer to like elements.

In FIG. 2A, for example, there are shown accommodations for velo binding via apertures 32, 34 along both the major and minor axis of housing 24, respectively. Similarly, in FIG. 2B there are shown accommodations for spiral binding along the major axis of housing 24 via apertures 36 and for two hole-punch binding via apertures 38 along the minor axis of housing 24. As seen in FIG. 2C, techniques of binding involving the use of an adhesive 40 such, for example, as glue, heat tape, or fast back, may also be employed.

Returning briefly to FIG. 1, it will be seen that to accommodate the detachable relationship of housing sections 24a and 24b, an interlocking tongue and groove arrangement may be used. FIGS. 2A-2C show various groove configurations, with FIGS. 2A and 2C employing a dovetail groove 42 along interior surface 44 of housing section 24b and FIG. 2B employing a circular groove 46. A rectangular groove 48 is provided in interior surface 50 along the minor axis of housing section 24b. Of course, it will be readily appreciated by those skilled in the art that resort may be had to a wide variety of conventional joining techniques suitable for securing detachable sections as 24a and 24b. It should be borne in mind, however, that a two-piece housing configuration such as the type depicted in FIGS. 1-2C is suggested merely in the interest of economic convenience, and it should not be regarded as a prerequisite for practicing the applicant's invention.

Although a three color active matrix type screen is preferred, it is also contemplated that less costly screen types, as for example, a mono-color liquid crystal display screen, may be also be employed. As best seen in FIG. 1, video display housing 24 is thin and flat—in the range of five to fourteen inches wide and preferably eight inches wide, and in the range of five to eighteen inches long and preferably eleven inches long, with a thickness in the range of 0.1 to 1.0 inches being preferred and a thickness of between 0.25 and 0.5 inches being especially preferred. The ratio of width and length to thickness is at least 5:1 and preferably in the range of 17:1 to 34:1. The video display document does not have an image taking lens, such as a zoom lens, or an image to data or signal transducer, such as a charge coupled device (CCD).

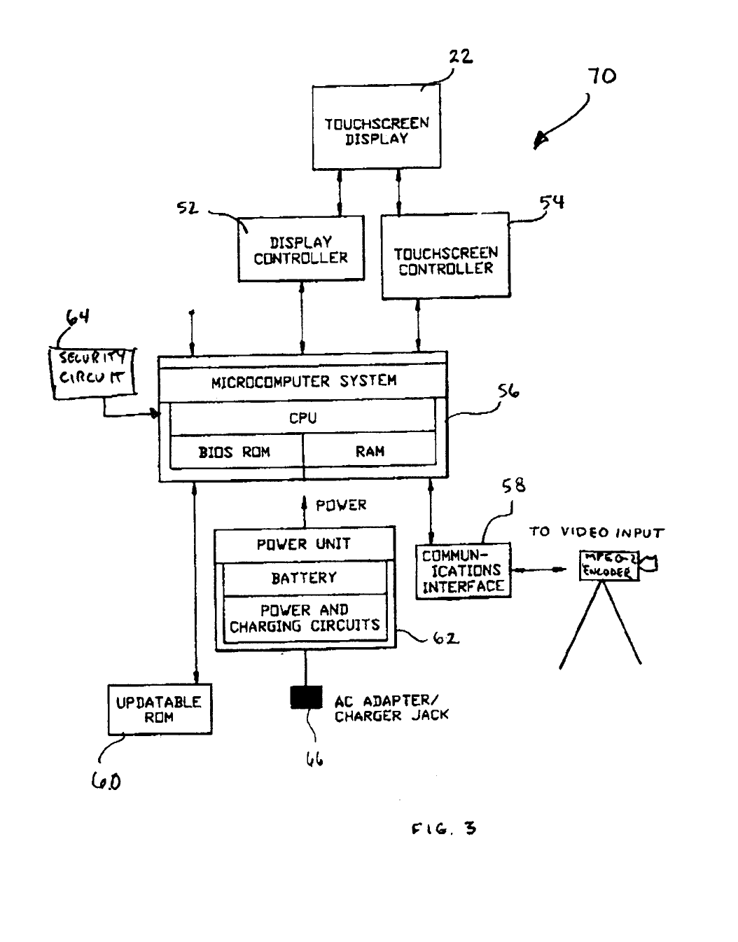

Turning now to FIG. 3, there is shown in block diagram form an illustrative configuration of the electronic processing system employed by video display device 12 in accordance with the present invention. As seen in FIG. 3, the electronic processing system 70 of video display device 12 of FIG. 1 comprises a single touch-sensitive display screen 22 mounted within housing section 24a (FIG. 1), display controller 52, touch screen controller 54, a microprocessor and memory module 56, a communication interface such as RS-232 port 58, an updateable memory storage unit 60 for storing input video sequence data, and an internal power unit 62 with battery, all configured into a handheld, portable unit.

Updateable video memory storage unit 60 serves to store video sequence data which, in accordance with an illustrative embodiment of the present invention, is received and stored as an avi or MPEG-2 encoded data file, with microprocessor system 56 being configured with appropriate software to function as an MPEG-2 or avi file decoder. Illustratively, the updateable ROM 60 memory storage device may comprise 500 to 1,000 megabytes or more of memory such as provided by PCMCIA memory storage cards, solid state EEPROMs, flash memory devices, bubble memory, a compact, large-capacity, miniature hard disk drive, or the like, depending upon the actual amount of information to be stored on the device By way of illustrative example, with a ROM memory storage device of approximately 300 megabytes, the video display device 12 of the present invention will have sufficient storage to store up to twenty minutes of compressed video data (and accompanying audio) in its entirety. In an especially preferred form of the invention, however, the updateable video or ROM memory storage 60 is permanently mounted within housing 24.

The electronic processing system of the illustrative embodiment of FIG. 3 controls and monitors the operations of the video display device 12 in accordance with user requests and under software control, the system comprising touch screen controller 54, display controller 52, microcomputer system 56 with random access memory (RAM), and security circuit 64. Microcomputer system 56 comprises the CPU which is controlled by the proprietary operating system embedded in a solid-state device, the BIOS ROM, and random access memory (RA) that provides the primary memory space to write, store and retrieve information and program instructions used by the CPU. The microcomputer system 56 comprises a general-purpose microprocessor with supporting circuitry such as a logic board with an Intel 486DX2/66MHz processor or better, or with a Pentium processor, a PowerPC processor with supporting circuitry such as a 100 MHz 603e processor; a RISC (reduced instruction set configuration) chip with supporting circuitry; or the like.

The video display device is powered from the power unit 62 that comprises one or more rechargeable batteries and power and charging circuits. These power and charging circuits control and distribute battery power or converted AC line power, control the charging of the internal battery or batteries when the device 12 is connected to an external AC adapter/charger device via the AC adapter/charger jack 66 and controls switchover between battery power and external AC line power when said AC power is available via the AC adapter/charger device. The rechargeable battery comprises a lithium ion battery, a nickel hydride (NiMH) battery, or the like. To use the system of the present invention actuates an on/off switch (not shown) which powers up the device. This action automatically applies power to the unit and displays the play, stop, fast forward, and rewind icons (not shown) on flat panel display 22.. When the user touches the play icon, playback of the stored video sequence is initiated and played in a continuous loop until the operator touches the stop, fast forward, or reverse icon or switches the system off.

When it is desired to replace the currently stored video sequence or video document with a new document, a computer having the appropriate data file stored thereon is coupled to communications interface 58 which, illustratively, is an RS-232 interface. Before such data can be transferred to video display device 12, the operator will be prompted to enter a security identification code unique to the system. This may be done, for example, using a numeric keypad displayed on the touch-screen of the device itself for entry by the user. In accordance with an especially preferred embodiment of the present invention, however, the user of the remote computer (not shown) seeking to download the new or replacement video data file will be prompted to enter the appropriate key code via the keyboard of that remote computer. In any event, upon successful recognition of the key code, the video data stream will be accepted and stored in updateable storage unit 60. Downloaded video data is received in compressed formatted, stored in the storage unit 60, and then automatically decompressed when reproduced.

It will, of course, be readily appreciated by those skilled in the art that the system of the present invention may be configured to handle video input in any desired format and to encode, compress, and decompress such signals as necessary to display the applicable video sequence when needed. For example, an MPEG-2 encoder may be integrally provided for receiving unencoded video input directly from a video input source and compressing the same for later decoding. The compressed digital data representing the video sequence (video motion sequence) is a “non-proprietary” compressed video data. Because it is non-proprietary it may be derived from the internet, as well as from all digital and analog camcorders. Such non-proprietary compressed video includes MCP (motion compensated prediction); (MCI) motion compensation interpolation; MPEG (Motion Pictures Experts Group) I or II; AVI; and International Telegraph and Telephone Consultative Committee (CCITT).

Touch screen display screen 22 is mounted on the upper, inside surface of the housing section 24a, extends virtually over the entire face thereof, and is electrically connected to the other circuits and components of the video display device 12. By way of illustrative example, touch screen display screen may be configured as a liquid crystal display (LCD) type screen or an active matrix display type screen that employs an array of addressable transistors such as thin-film transistors (TFT) or the like, wherein each color dot or pixel is activated by a group of three transistors, one each for red, green and blue. Various embodiments of the video display device comprise differing screen and case sizes to suit the needs of the various traditional printed media sizes. For the reasons discussed above, however, an overall housing size of 8 ½ inches by 11 inches, taken with the miniaturization of the conventional electronic components employed herein, will typically serve as the decisive criteria in selecting the final size. Although a VGA 640 by 480 pixel resolution LCD or active matrix display provides acceptable detail for text and for some graphics, the preferred display for motion-video clips has at least a 800 by 600 pixel resolution and at least 256 colors.

In the embodiment of FIGS. 1-3, a touch-sensitive transparent plate (not shown) covers the screen and is further comprised of resistive touch, capacitive touch, infrared beam touch, or the like. A typical touch screen is the thin film transparent plate using resistive touch technology manufactured by Dynapro Corporation. The touch-sensitive transparent plate used in the video display device of the present invention is typically less than 0.01 inch in thickness. A flexible flat cable is typically used to connect the touch-sensitive transparent plate to its touch screen controller; although other connections methods are also employable. The touch-sensitive plate contains a matrix of touch-sensitive areas over its entire surface. The outlines of these areas can be programmed to be recognized to coincide with graphics or other information displayed on the underlying display screen.

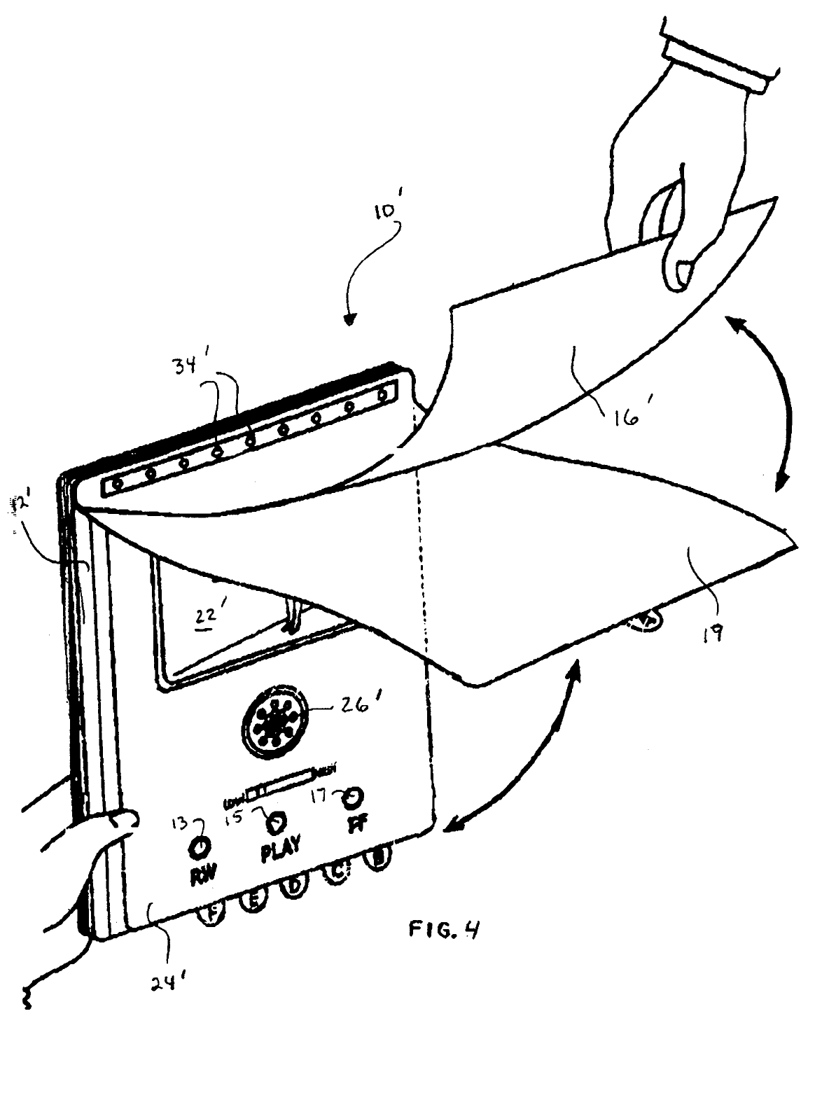

Turning now to FIG. 4, there is shown a hybrid document 10′ constructed in accordance with an alternative embodiment of the present invention. Internally, the video display device 12′ of the present invention is almost identical to the system depicted in FIG. 3. Essentially, the differences therebetween relate to the substitution of a single section housing 24′, as well as discrete mechanical pushbuttons 13, 15, and 17 (as opposed to a touch screen interface) for the Rewind (RW), Play, and Fast Forward (FF) command input functions. Corresponding modifications to the internal circuitry which are needed to accommodate the use of a mechanically actuated operator interface are believed to be well within the level of skill of the ordinary artisan and a detailed illustration and discussion of the same has been omitted herein for clarity.

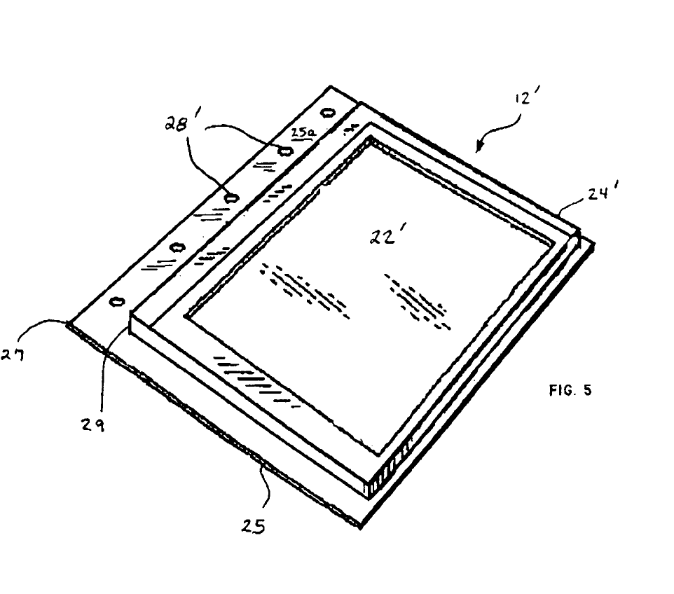

With particular reference now to FIG. 5, there is shown a video display document 12′ including housing 24′ and display 22′ contained therein. Essentially, the construction of the video display device itself is similar in all respects to the embodiments of FIGS. 1 and 4. However, in the embodiment of the invention depicted in FIG. 5 a binding attachment 25 is included to provide both a suitable binding surface 25a for mounting in a holder 14 (FIG. 1). In an especially preferred form of this embodiment, the binding attachment 25 comprises a thin panel of resilient, flexible material as, for example, a tear resistant vinyl or the like, which advantageously allows the device to be manipulated in the same fashion as a sheet of printed material within the holder.

As seen in FIG. 5, binding attachment 25 (which may also be considered a second section of the housing) and housing 24′ (which may also be considered a first section of the housing) are disposed in laminar relation. As will be readily ascertained by those skilled in the art, the respective sections may be affixed together using any conventional fastening technique (not shown), including, by way of non-limiting example, adhesives, mechanical fasteners, hook and loop fasteners, and the like. The binding attachment 25 has a thickness which is substantially less than the thickness of housing 24′, illustratively 0.125″, and has a lateral peripheral edge 27 extending beyond a lateral peripheral edge 29 of housing 24′ to allow extending surface 25a to be used as a binding surface.

In the illustrative embodiment of FIG. 5, binding surface 25a defines at least a first plurality of aligned apertures 28′. Of course, the pattern of aligned apertures shown in FIG. 5 is for illustrative purposes only and it will be understood by those skilled in the art that the precise configuration will be selected in accordance with the actual binding technique to be used. In that regard, a principal advantage of the binding attachment of FIG. 5 is that the specific hole pattern need not be known in advance. Rather, the specific hole pattern can be decided well after purchase and thereafter stamped, punched, drilled or otherwise formed in surface 25a, as appropriate for the intended use.

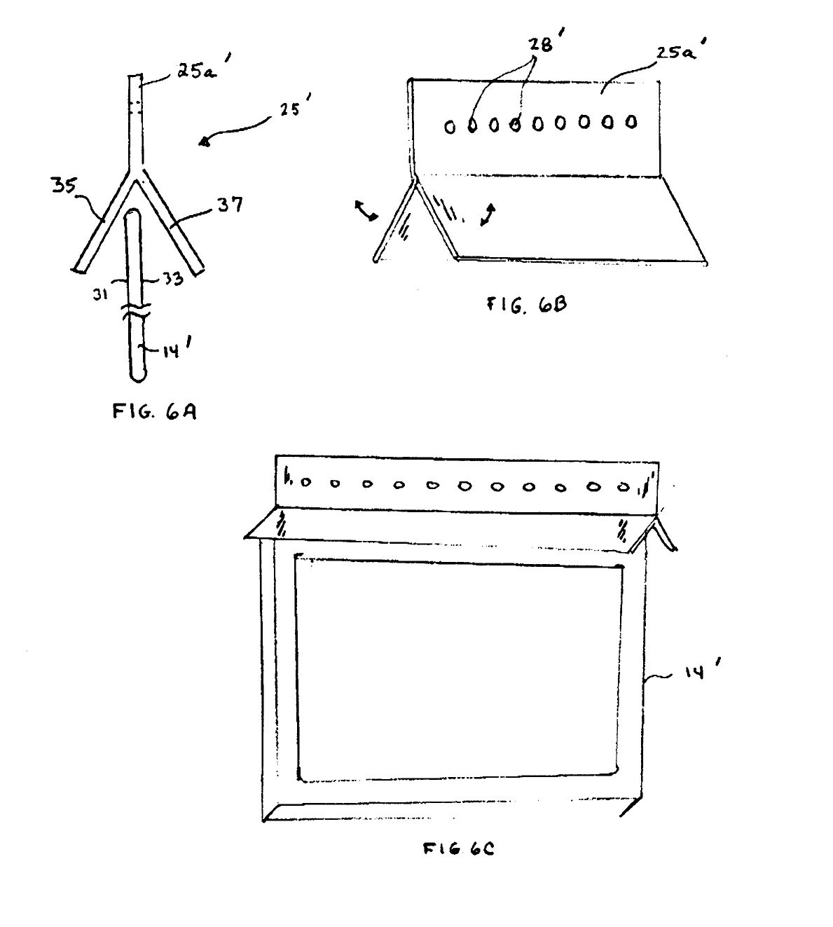

Turning now to FIGS. 6A and 6B, there is shown a modified binding attachment 25′ which, when attached to housing 14′ in the manner shown in FIG. 6C, provides a document with the same ease of use and general features as the embodiment depicted in FIG. 5. As seen in FIG. 6C, at least one edge 29′ of housing 24′ is straight and housing 24′ has a front surface 31 and a back surface 33. As best seen in FIGS. 6A and 6B, binding attachment 25′ comprises a binding panel 25a′ adapted to be bound into a holder (not shown) and having attached thereto front and back panels, indicated at 35 and 37, respectively. In use, front panel 35 is adhered, affixed, or otherwise secured to housing 24′ at the front surface 31 along a straight edge of the housing as edge 29′. Similarly, back panel 37 is adhered, affixed, or otherwise secured to housing 24′ at the rear surface 33 of housing 24′ along the same straight edge, illustratively, edge 29′. Like binding surface 25a of FIG. 5, binding panel 25a′ may be stamped, punched, drilled or otherwise operated upon to define an aligned set of apertures to accommodate the binding technique selected by the purchaser or user.

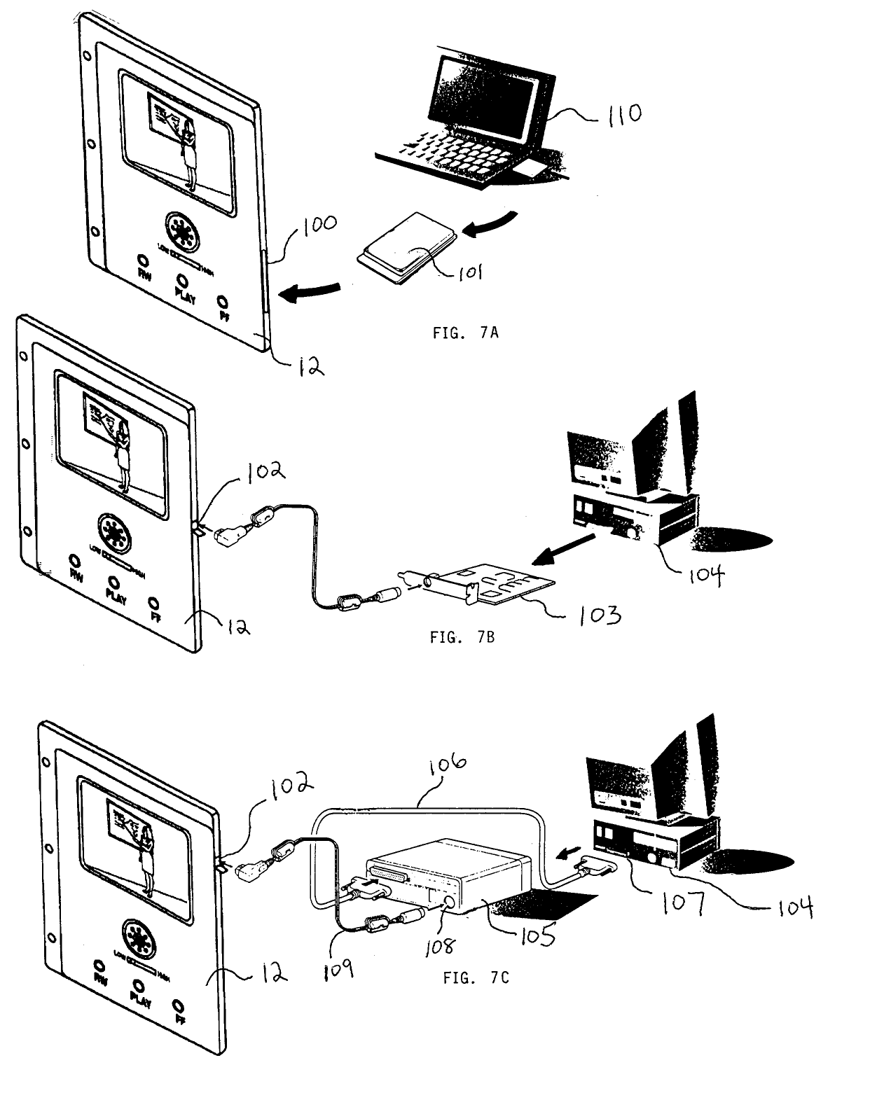

With reference now to FIGS. 7A-7C, there are shown various methods for providing an interface to download information into the video display device. Specifically, the video display device includes a communication interface port for receiving non-proprietary compressed digital data representing a video motion sequence. In the illustrative example of FIG. 7A, the interface port 100 comprises a PCMCIA card slot for receiving a PCMCIA memory card 101 having stored thereon compressed digital data representative of a video motion sequence. The data is written onto card 101 by lap top computer 110. In the illustrative examples of FIGS. 7B and 7C, a video input interface 102 is provided for interacting directly with the ISA or other video card 103 of a PC 104 (FIG. 7B) or with a CD-ROM reader having stored thereon compressed information to be transferred to the video memory of the video display. In FIG. 7C the converter box 105 is connected by cable 106 to the printer port 107 of PC 104 and provides an ISO output port which is connected to cable 109. Alternatively, an RS-232 port (not shown) may be provided.

Although the video sequence displaying function of the present invention has been emphasized in the preceding examples, it is contemplated by the inventor herein that various other categories of information may also be stored and displayed. In lieu of or in addition to live action video, one or more animated scenes may be stored and displayed. Or, in the context of a business presentation or an investors relations meeting, a sequence of graphs or charts, each representing an individual “snapshot” of a monitored corporate indicator taken over the course of a particular time interval may be stored and displayed in seriatim and sufficiently rapid to convey movement, as for example, to show the progressive growth in a company's earnings per share, gross sales, stock price, market share or some other measurement of management performance. In accordance with the latter embodiment, the provision of one or more additional touch screen or pushbutton operator(s) permitting the user to scroll backward and/or forward through each successive scene or “document” is especially preferred. Indeed, it is contemplated by the inventor herein that using the system of the present invention, entrepreneurs and others seeking capital contributions or investment may create “video prospecta” in much the same way as printed materials are currently used. Thus, as utilized herein, the term “video sequence” should be understood to refer to any stored collection of scenes, charts, graphs, pictures, or the like which may be organized and sequentially displayed utilizing a video display device such as the one employed in the illustrative embodiments of FIGS. 1 and 4.

By way of more specific example, the video display device of the present invention may be employed to store individual slides, forming a detailed slide show that may, if desired, be accompanied by audio explanations. Yet additional realizations of the present invention may be to provide product demonstrations and/or instructions on the use of a product. As such, while only a few embodiments have been illustrated and described, many variations may be made in the design and configuration without departing from the scope of the invention as set forth in the appended claims.

What is claimed is:

1. A video display device simulating and representing a document comprising a video sequence, the device being without an image acquiring lens and an image to signal transducer, the device comprising:
a housing having a maximum thickness of less than one inch and having a ratio of each of width and length to maximum thickness of at least five to 1;
a flat panel display received within said housing;
a machine-readable video storage module operative to store, as data, said video sequence;
an operator interface for inputting a user playback command, said operator interface comprising one of a pushbutton operator and a touch screen operator displayed on said flat panel display; and
a processor operatively associated with the video storage module, said processor being responsive to said user playback command to cause stored video data to be read from said video storage module.

2. The video display device of claim 1, wherein said operator interface comprises a touch screen interface defining a first touch screen operator for initiating playback of the video sequence, a second touch screen operator for initiating rewinding of the video sequence, and a third touch screen operator for initiating fast forwarding of the video sequence.

3. The video display device of claim 1, wherein said housing is thin and flat and has a width of eight and one-half inches, a length of eleven inches, and a thickness of less than about one-half inches.

4. The video display device of claim 1, wherein said housing comprises a first section and a second section, said first section being detachably coupled to said second section and containing said flat panel display, said video storage module; and said processor, wherein said second section defines at least a first plurality of aligned apertures dimensioned and arranged to permit binding with printed materials to form an integrated hybrid document.

5. The video display device of claim 4, wherein said first section and said second section are slideably engageable to facilitate mutual attachment and detachment thereof.

6. The video display device of claim 4, wherein said first plurality of aligned apertures are dimensioned and arranged to accommodate one of a three-hole punch, a two hole punch, a spiral, a velo, a coil, or a stitch technique of binding along a major axis of said display device when said first and second sections are assembled.

7. The video display device of claim 4, wherein said second section further includes a second plurality of aligned apertures, said second plurality of apertures being dimensioned and arranged to accommodate one of a three-hole punch, a two hole punch, a spiral, a velo, a coil, or a stitch technique of binding along a minor axis of said display device when said first and second sections are assembled.

8. The video display device of claim 4, wherein said first and second sections of said housing are disposed in laminar relation, with said second section having a thickness substantially less than said first section and having a lateral peripheral edge extending beyond a lateral peripheral edge of said first section to thereby provide a surface defining said at least a first plurality of aligned apertures.

9. The video display device of claim 8, wherein said first section is made of a rigid material and said second section is made of a flexible material.

10. An integrated, hybrid document comprising, in combination;
a video display device simulating and representing a video sequence, the device being without an image taking lens and an image to signal transducer, the device including
a housing having a maximum thickness of less than one inch and having a ratio of each of width and length to maximum thickness of at least five to one,
a flat panel display received within said housing,
a machine-readable video storage module operative to store, as data, said video sequence;
an operator interface for inputting a user playback command, said operator interface comprising one of a pushbutton operator and a touch screen operator displayed on said flat panel display; and
a processor operatively associated with the video storage module, said processor being responsive to said user playback command to cause stored video data to be read from said video storage module;
at least one sheet of printed material; and
means for binding said video display device and said at least one sheet of printed material.

11. The integrated, hybrid document of claim 10, wherein said means for binding is configured to provide at least one of velo, spiral, coil, three-ring, and two-ring binding of said video display device and said at least one sheet of printed material along a major axis thereof.

12. The integrated, hybrid document of claim 11, wherein said means for binding is configured to provide at least one of velo, spiral, coil, three-ring, and two-ring binding of said video display device and said at least one sheet of printed material along a minor axis thereof.

13. The integrated, hybrid document of claim 10, wherein said housing is thin and flat and has a width of eight and one-half inches, a length of eleven inches, and a thickness of less than about one-half inches.

14. The integrated, hybrid document of claim 10, wherein said housing comprises a first section and a second section, said first section being detachably coupled to said second section and containing said flat panel display, said video storage module; and said processor, wherein said second section defines at least a first plurality of aligned apertures dimensioned and arranged to permit insertion of said means for binding.

15. The integrated, hybrid document of claim 14, wherein said first section is substantially thicker than said second section.

16. The integrated, hybrid document of claim 10, wherein said first and second sections of said housing are disposed in laminar relation, with said second section having a thickness substantially less than said first section and having a lateral peripheral edge extending beyond a lateral peripheral edge of said first section to thereby provide a surface defining said at least a first plurality of aligned apertures.

17. The video display device of claim 16, wherein said first section is made of a rigid material and said second section is made of a flexible material.

18. A method of preparing and presenting at least one video sequence defining a video document, comprising the steps of:
providing a video display device including a housing which is thin and flat and having a ratio of each of width and length to thickness of at least five to one, a flat panel display, a machine-readable video storage module operative to store data representative of a video sequence to be presented, an operator interface for inputting a user playback command, the operator interface comprising one of a pushbutton operator and a touch screen operator displayed on the flat panel display, and a processor operatively associated with the video storage module, the processor being responsive to said user playback command to cause stored video data to be read from the video storage module, the video display device being without an image taking lens and an image to signal transducer; and
supplying a signal representative of one of a video sequence, a slide show presentation, an animated scene, and a progressive sequence of charts to the video storage module for storage therein.

19. The method of claim 18, further including a step of inputting a security code prior to and as a condition of performing said supplying step.

20. The method of claim 19, wherein said supplying step comprising attaching a remote computer having a keyboard to said video display device, and wherein said security code inputting step comprising employing said keyboard to enter said security code.

21. The method of claim 18, further including a step of binding the video display device to at least one sheet of printed material, to thereby form a hybrid, integrated document.

22. The method of claim 18, further including a step of attaching the housing of the video display device to a thin flat panel, the thin flat panel having a lateral peripheral edge extending beyond a lateral peripheral edge of the housing providing therebetween a surface for defining at least a first plurality of aligned apertures.

23. A method of displaying at least one video sequence defining a video document, said method comprising the steps of:
providing a video display device including a housing which is thin and flat and having a ratio of each of width and length to thickness of at least five to one, a flat panel display, a machine-readable video storage module operative to store data representative of a video sequence to be presented, an operator interface for inputting a user playback command, the operator interface comprising one of a pushbutton operator and a touch screen operator displayed on the flat panel display, and a processor operatively associated with the video storage module, the processor being responsive to said user playback command to cause stored video data to be read from the video storage module, the video display device being without an image taking lens and an image to signal transducer and said video storage module having stored therein data representative of at least one of a video sequence, a slide show presentation, an animated scene, and a progressive sequence of charts to the video storage module for storage therein; and
inputting a user playback command causing said video display device to display said at least one of a video sequence, slide show presentation, animated scene, and progressive sequence of charts.

24. A video display device which is an entirely solid state device without moving parts except for switches and which is a play back device without an image acquiring lens and an image to signal transducer, the display device comprising:
a housing which is thin and flat, having a ratio of at least five to one; and
within the housing
flat panel display means to display a video motion sequence;
a video memory means to receive and store compressed data representing the video motion sequence;
manual switch means to be user operated to start the video sequence; and
microcomputer processor means to control the reading of data from the video memory means, decompression of the data, and display of the decompressed data on the flat panel display means in response to operation of the switch means.

25. A video display device as in claim 24, wherein at least one edge of the housing is straight and the housing has a front and a back, the video display device further including
a binding strip having a binding panel adapted to be bound into a holder and having attached thereto front and back panels, the front panel being adhered to the housing at the front along the at least one edge, and the back panel being adhered to the housing at the back along the at least one edge.

26. A video display device which is an entirely solid-state device without moving parts, except for switches, and which is only a play-back device without an image acquiring lens and an image-to-signal transducer, the video display device comprising:
a housing which is thin, having a maximum thickness of one inch, and within the housing electrically connected together
a battery;
a communication interface port means for receiving non-proprietary compressed digital data representing a video motion sequence;
a flat panel display means for displaying a video motion sequence;
video memory means for receiving and storing the compressed digital data;
manual switch means to be user-operated to start the video motion sequence; and
microcomputer processor means for controlling reading of the digital data from the video memory means, decompressing the digital data, and display of the decompressed digital data as a video sequence on the flat panel display means.

27. A video display device as in claim 26, wherein the communication interface port means comprises and RS-232 port.
